(19) United States
(12) Patent Application Publication
(10) Pub. No.: US 2010/0258367 A1
(43) Pub. Date: Oct. 14, 2010

(54) TRAVEL DRIVE SYSTEM WITH MULTIPLE TRANSMISSION PATHS FOR HYBRID VEHICLE AND METHOD USING SAME

(76) Inventor: Stéphane Venturi, Roiffieux (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/682,253

(22) PCT Filed: Oct. 7, 2008
(86) PCT No.: PCT/FR08/01399

§ 371 Date: Jun. 21, 2010

(30) Foreign Application Priority Data
Oct. 10, 2007 (FR) 0707118

(51) Int. Cl. B60K 6/20

(52) U.S. Cl. 180/65.21

(57) ABSTRACT

The present invention relates to a travel drive system for a hybrid vehicle, comprising a thermal engine (10), notably an internal-combustion engine, with a shaft (12), at least one electric machine (14) with a rotor (16) supplied by batteries (18), a disengageable coupling (22) between said shaft and said rotor, and a driven shaft (42) driving the wheels of the vehicle.

According to the invention, the system comprises a first transmission path (36) for motion transmission between shaft (12) of thermal engine (10) and driven shaft (42), and a second transmission path (40) for motion transmission between rotor (16) of machine (14) and said driven shaft.

### FIELD OF THE INVENTION

The present invention relates to a drive system, traction or propulsion drive, for hybrid type vehicles.

This type of vehicles generally combines a thermal engine, mainly an internal-combustion engine, and an electric machine connected to an electric source, such as one or more electric accumulators, for propelling them. This combination allows the energy efficiency of the drive system to be optimized while decreasing the total fuel consumption and limiting emissions.

### BACKGROUND OF THE INVENTION

In the example described in document FR-2,670,440, the thermal engine comprises an output shaft that drives the motive part of a variable transmission, such as a variable speed drive, and whose transmission receiving part is connected to the motive axle of the vehicle. The output shaft carries, between the thermal engine and the variable speed drive, an electric machine connected to an electric battery and two clutches, a first clutch between the thermal engine and the electric machine, and a second clutch between the electric machine and the variable speed drive.

When the vehicle is to be driven with a high torque available over a wide speed range while limiting exhaust gas emissions and noise generation, as in an urban site, the electric machine is preferably used for driving the motive axle of the vehicle and, consequently, the driving wheels of this vehicle.

On the other hand, for uses where a high engine driving power and a wide operating range are required, the thermal engine is used for driving the motive axle and thus providing displacement of the vehicle.

Although satisfactory, this drive system however involves some significant drawbacks.

In fact, when only the electric machine is used to drive the vehicle, sufficient torque and/or power is required for driving the vehicle as well as overcoming all the resistances (inertia, friction, . . . ) of the variable transmission. Furthermore, during vehicle braking operations, part of the energy released thereby is absorbed by the variable speed drive and only another part of this energy is recovered, then converted by the electric machine.

If a mechanical gearbox is used instead of the variable speed drive, it is essential to change the gear ratio in order to recover the braking energy. It is therefore necessary to disengage the motive axle, which causes a break in the motion transmission and an interruption of the braking energy recovery.

The present invention aims to overcome the aforementioned drawbacks by means of a simple drive system that requires no complicated control devices for the various uses of the system.

### SUMMARY OF THE INVENTION

The invention therefore relates to a travel drive system for a hybrid vehicle comprising a thermal engine, notably an internal-combustion engine, with a shaft, at least one electric machine with a rotor supplied by batteries, a disengageable coupling between said shaft and said rotor, and a driven shaft driving the wheels of the vehicle, characterized in that it comprises a first transmission path for motion transmission between the shaft of the thermal engine and the driven shaft, and a second transmission path for motion transmission between the rotor and said driven shaft.

At least one of the paths can comprise a variable gear transmission.

The transmission can comprise a variable gear transmission.

The continuously variable gear transmission can comprise two pairs of variable spacing pulleys connected by a belt.

Alternatively, the variable gear transmission can comprise a gear box.

At least one of the paths can comprise a fixed gear transmission.

The fixed gear transmission can comprise two pulleys connected by a belt.

The system can comprise a disengageable coupling between the rotor of the electric machine and the second transmission path.

The system can comprise a coupling between the first transmission path and the engine shaft.

The system can comprise at least one coupling between the driven shaft and the first transmission path.

The coupling can comprise a centrifugal coupling.

The coupling can comprise a one-directional coupling.

The coupling can comprise a disengageable coupling.

The system can comprise an additional electric machine driven by the engine.

The invention also relates to a method intended for travel drive of a hybrid vehicle comprising a thermal engine, notably an internal-combustion engine, with a shaft, at least one electric machine with a rotor supplied by batteries, a disengageable coupling between said shaft and said rotor, and a driven shaft driving the wheels of the vehicle characterized in that it consists in connecting the driven shaft by a first motion transmission path to the shaft of the thermal engine and/or by a second motion transmission path to the rotor of the electric machine.

The method can consist, for starting the thermal engine, in supplying the electric machine by means of the batteries so as to operate it as an electric starter and in connecting the rotor of this machine to the engine shaft through the coupling.

The method can consist, jointly with the operation of the thermal engine and drive of the driven shaft by the first transmission path, in charging the batteries through actuation of the electric machine via the coupling between the engine shaft and the machine rotor.

The method can consist, jointly with the operation of the thermal engine and drive of the driven shaft by the first transmission path, in driving said driven shaft by means of the electric machine by connecting the rotor thereof to the engine shaft.

The method can consist, jointly with the operation of the thermal engine and drive of the driven shaft by the first transmission path, in driving said driven shaft by means of the electric machine through the agency of the second transmission path.

The method can consist, jointly with the operation of the thermal engine and drive of the driven shaft by the second transmission path, in driving said driven shaft by means of the thermal engine by connecting the shaft thereof to the rotor through the coupling.

The method can consist, during deceleration phases of the vehicle, in recovering the mechanical energy of the driven shaft in order to transmit it to the rotor of the electric machine by connecting said rotor to the second transmission path through the coupling.

The method can consist, during deceleration phases of the vehicle, in recovering the mechanical energy of the driven shaft in order to transmit it to the rotor of the electric machine by connecting said rotor to the second transmission path through the coupling and to transmit it to the engine shaft by making the coupling between the rotor and the shaft operational.

### BRIEF DESCRIPTION OF THE FIGURES

Other features and advantages of the invention will be clear from reading the description hereafter, given by way of non limitative example, with reference to the accompanying figures wherein:

FIG. 1 is a diagram showing a drive system for a hybrid vehicle according to the invention,

FIGS. 2 to 14 show the system of FIG. 1 from a first operating configuration to a thirteenth configuration, and

FIGS. 15 to 21 illustrate different variants of the system according to the invention.

### DETAILED DESCRIPTION

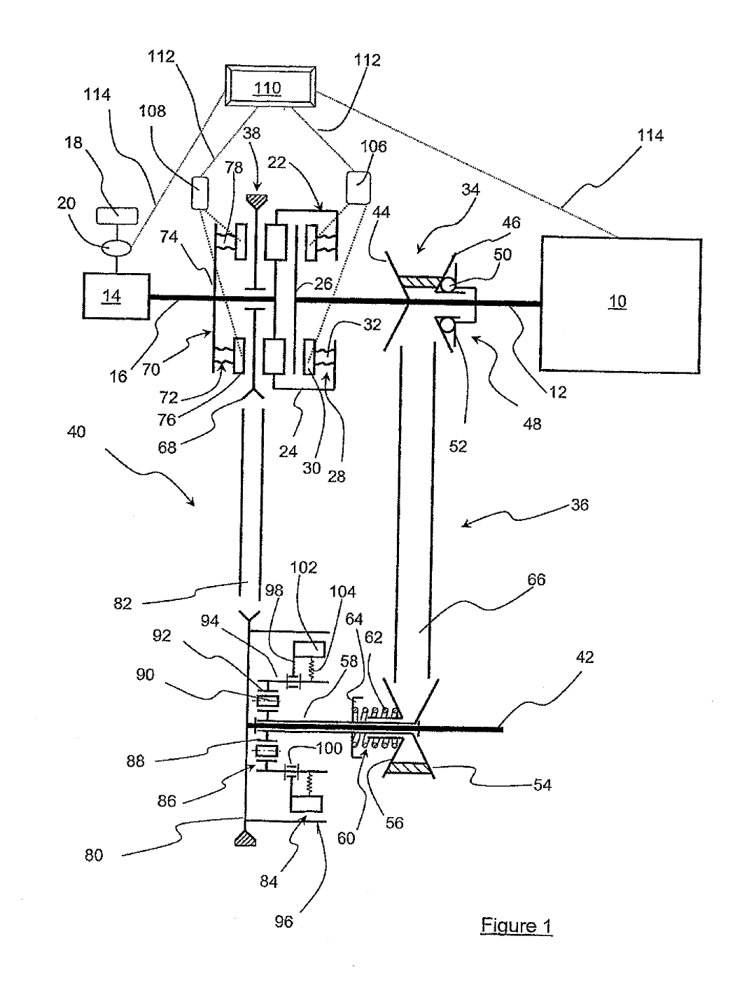

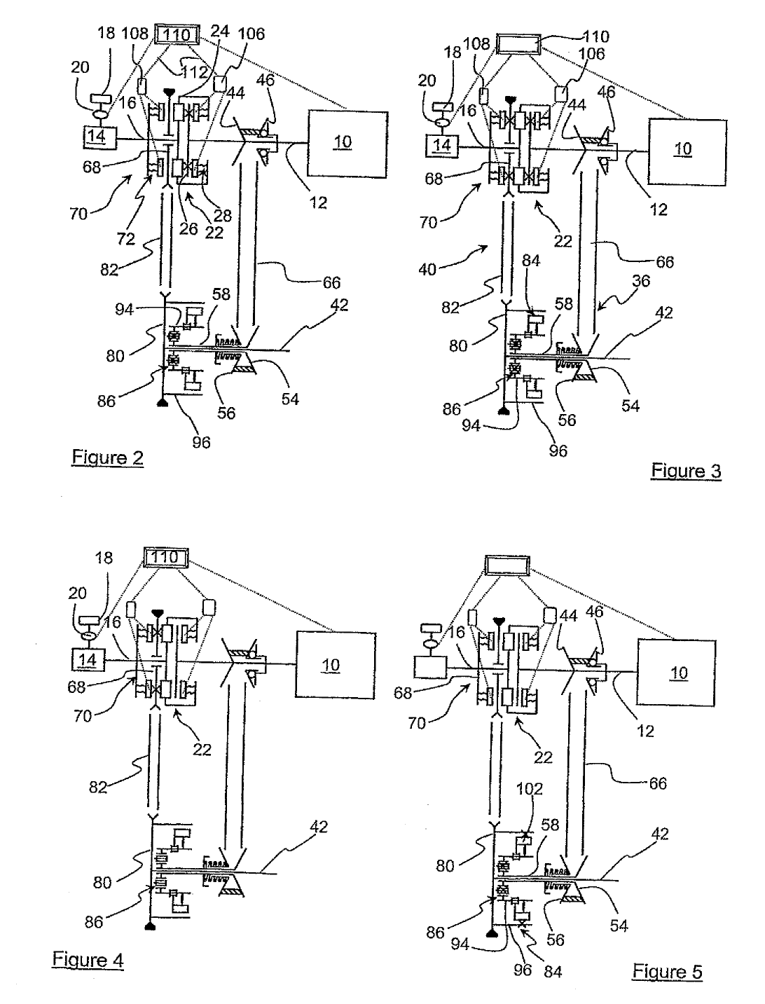

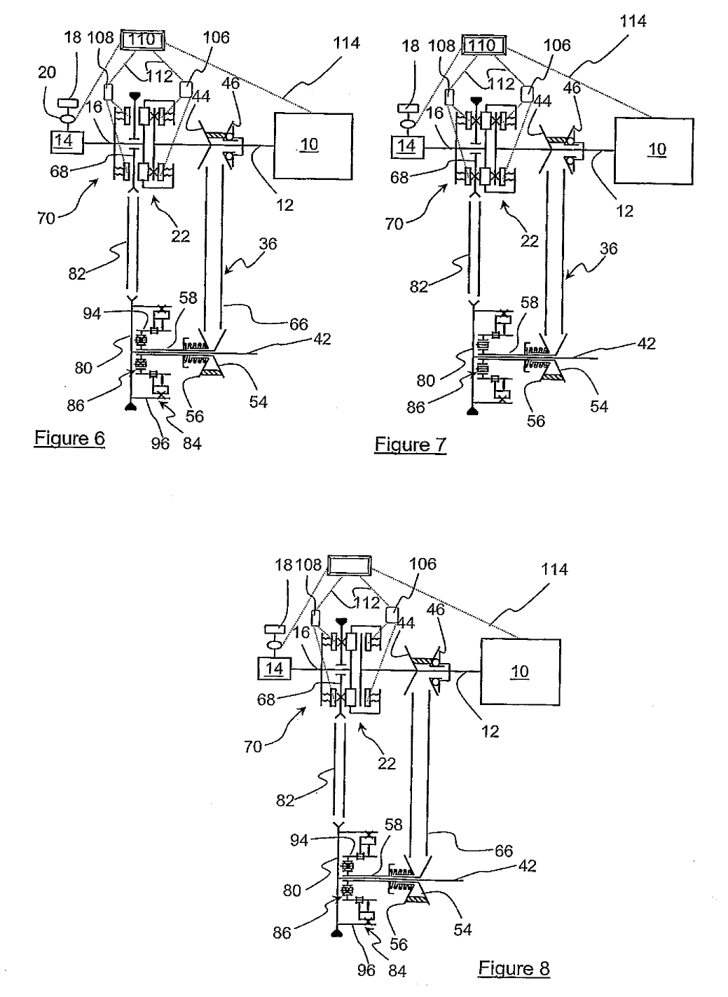

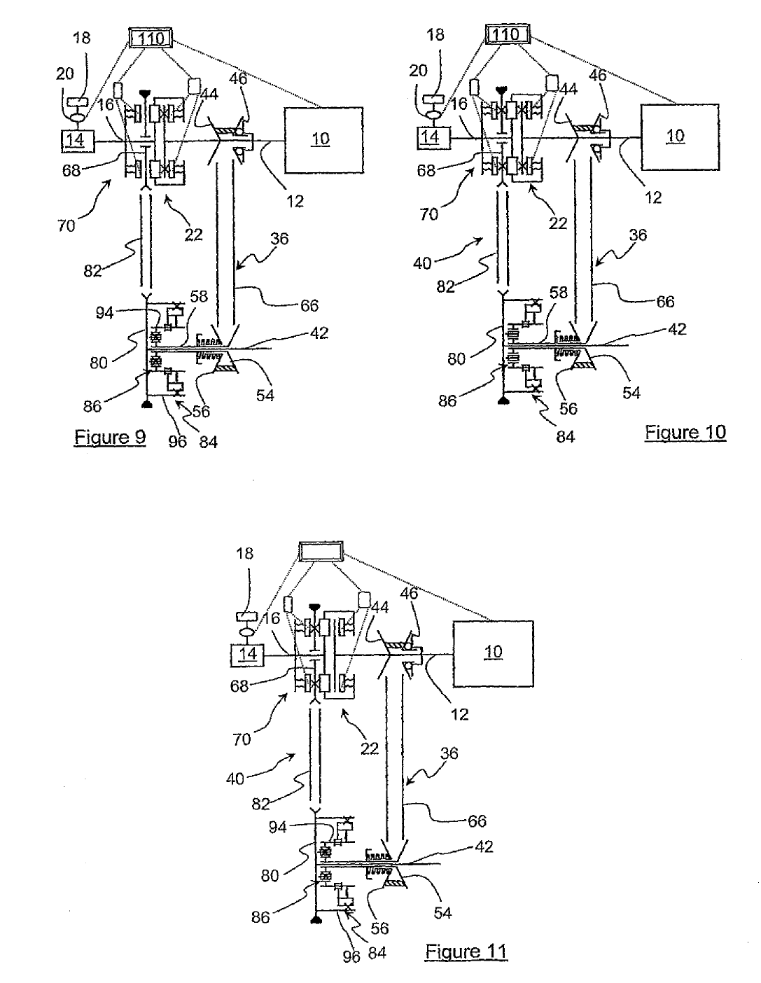

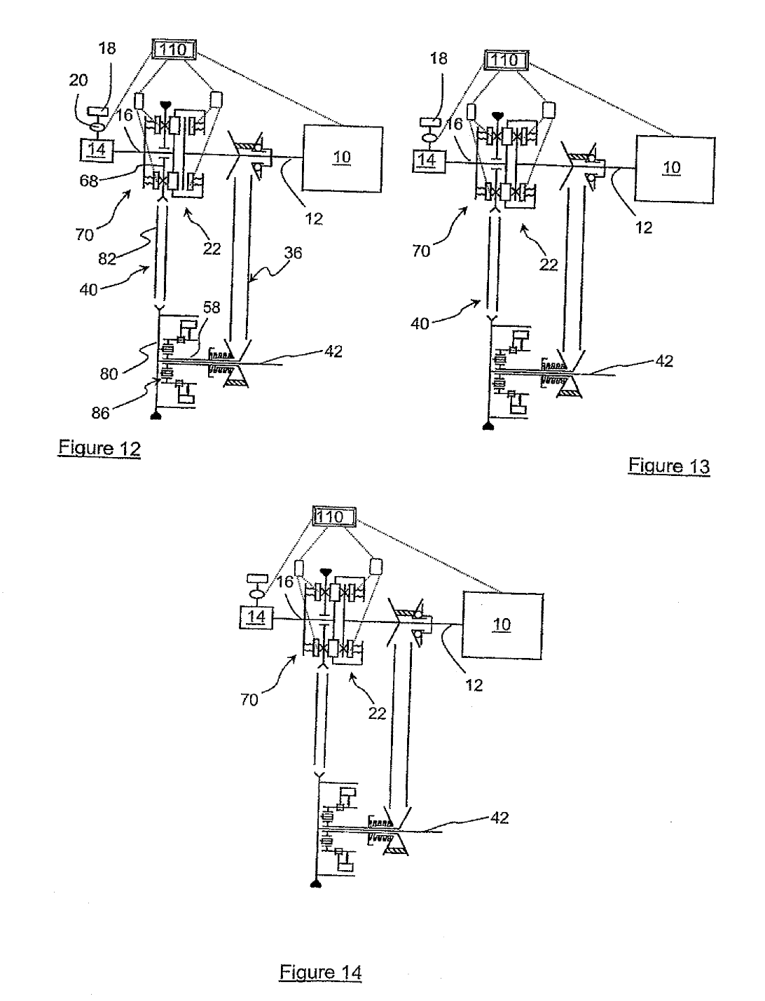

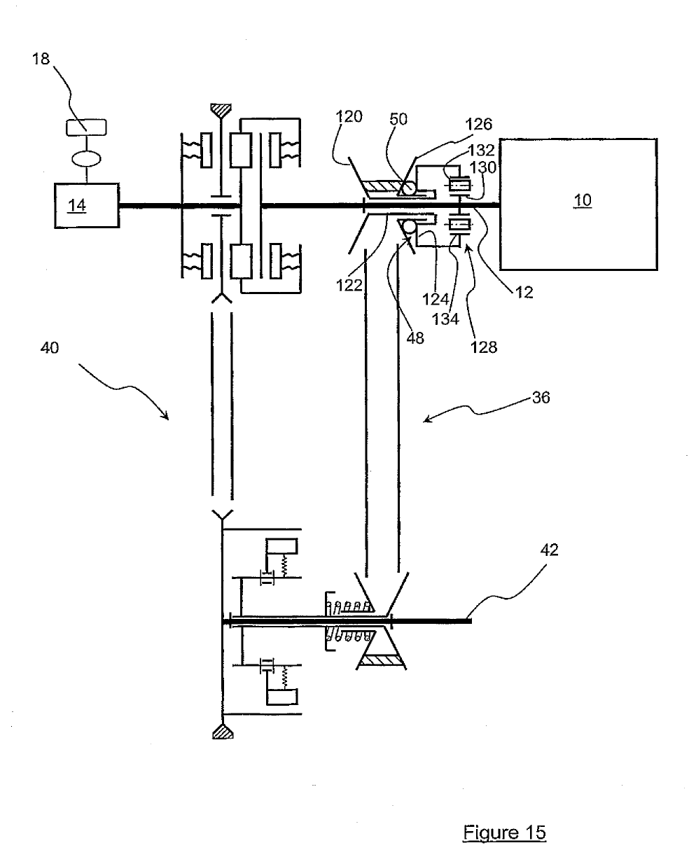

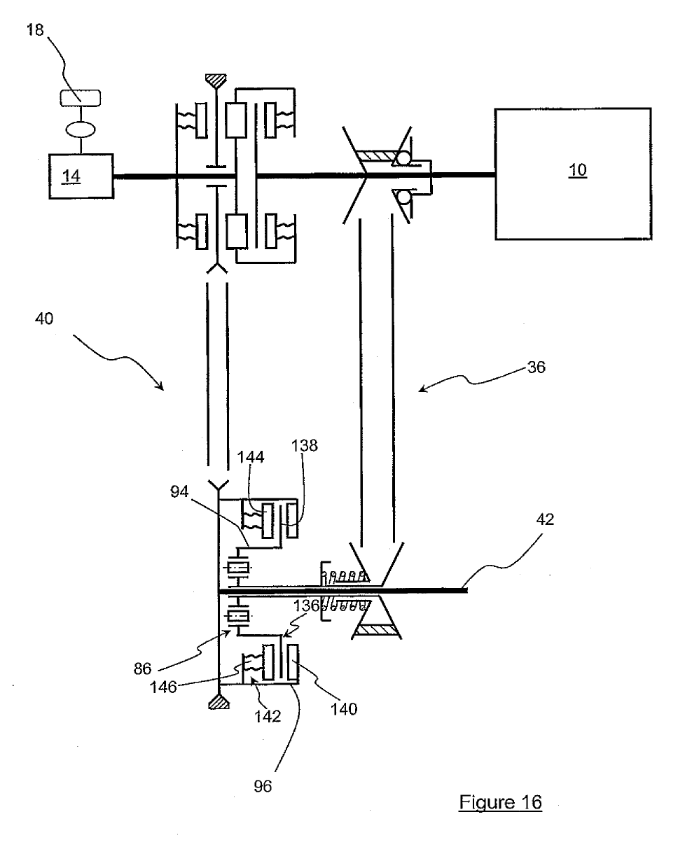

As illustrated in FIG. 1, the system for driving a hybrid vehicle comprises a thermal engine 10, notably an internal-combustion engine, with a shaft 12 and an electric machine 14 that can work in electric motor mode or in electric energy generator mode, with a rotor 16. This machine is supplied by electric accumulators 18 (or batteries) while being controlled by a control device 20.

Shaft 12 of thermal engine 10 and rotor 16 of electric machine 14 are connected to one another by a disengageable coupling 22. This coupling comprises a housing 24 fixedly carried in rotation and in translation by the end of rotor 16 with respect to this rotor. This coupling also comprises a coupling disc 26 arranged in the housing while being fixedly carried in rotation by the end of shaft 12 and freely in axial translation on this shaft. The coupling also comprises pressure means 28 arranged in housing 24, allowing to provide coupling between the disc and the housing, thus enabling simultaneous rotation of the rotor and of the shaft. By way of example, these pressure means comprise a pressure plate 30 subjected to the action of elastic means, generally in form of Belleville washers or coil springs.

Shaft 12 also carries, between coupling 22 and thermal engine 10, an element 34 of a first motion transmission path 36, preferably of variable gear, while rotor 16 carries, between coupling 22 and electric machine 14, an element 38 of a second motion transmission path 40, advantageously of fixed gear.

These two transmission paths, preferably arranged parallel to one another, are provided to control, separately or simultaneously, a driven shaft 42 advantageously arranged parallel to the shaft and to the rotor. This driven shaft is connected to a motive axle, directly or by means of a transmission, like a differential bridge, allowing the driving wheels of the engine (not shown) to be driven.

These motion transmission paths allow any rotating motion of the rotor and/or of the shaft, as well as any torque and/or power generated by this shaft and/or this rotor to be transmitted to the driven shaft.

The first variable gear transmission path, with a continuously variable gear here, comes in form of a speed variator with variable pulleys. This variator generally consists of two pairs of opposite conical discs driven by a trapezoidal belt. The first pair of opposite conical discs comprises a conical disc 44 carried fixedly in rotation and in translation on shaft 12 and another disc 46 that is mobile while being mounted fixed in rotation but free in translation on this shaft. Means 48 for controlling the translational displacement of conical disc 46 are provided so as to allow control of the spacing between these two conical discs. Advantageously, as it is widely known, these means are centrifugal means with weights 50 that rest, on the one hand, on a flange 52, fixed in translation and in rotation, carried by shaft 12 while being substantially perpendicular to this shaft and, on the other hand, on the outer face of mobile conical disc 46.

Driven shaft 42 carries the second pair of opposite conical discs 54, 56 arranged opposite the first pair of discs 44, 46. Conical disc 54 facing conical disc 46 is fixedly mounted on a sleeve 58 coaxial to driven shaft 42, this sleeve being free in rotation with respect to this shaft but fixed in translation with respect thereto. The other conical disc 56 opposite conical disc 44 is fixed in rotation with respect to disc 54 but mobile in translation on sleeve 58 under the action of elastic means 60. These elastic means come here in the form of a spring 62 resting on the outer face of conical disc 56 and on a plate 64 orthogonal to sleeve 58.

The two pairs of conical discs are kinetically connected to one another by a trapezoidal belt 66 or by any other equivalent means.

Thus, any variation in the spacing of the discs at the level of the first pair of conical discs 44, 46 under the effect of control means 48 is translated into a variation in the spacing of conical discs 54, 56 under the combined effect of the elastic means and of the translational displacement of belt 66 in an orthogonal direction to shafts 12 and 42. Driven shaft 42 therefore undergoes a speed variation that depends on the spacing of the conical discs.

The other transmission path, preferably of fixed gear, comprises a pulley 68, preferably notched, mounted loose on rotor 16 but that can be connected in rotation to this rotor under the effect of a disengageable coupling 70. The pulley is therefore arranged between housing 24 of coupling 22 and pressure means 72 carried by a flange 74 fixedly connected to shaft 16.

Pressure means 72 are advantageously similar to those described above with a pressure plate 76 and elastic means 78. This second transmission path also comprises another pulley 80, also preferably notched, which is fixedly mounted on driven shaft 42. A motion transmission means 82 such as a preferably notched belt allows the rotating motion of one of the pulleys to be transmitted to the other one.

A coupling 84, preferably centrifugal, controlled by a one-directional coupling 86 such as a free wheel, is housed between fixed pulley 80 and the pair of conical discs 54, 56 arranged on driven shaft 42.

As it is known per se, free wheel 86 comprises an inner ring 88 connected to sleeve 58, rollers 90 (or balls) resting on the inner ring and on an outer ring 92 connected to an axial collar 94.

Centrifugal coupling 84 is arranged between collar 94 and a fixed axial drum 96 carried by fixed pulley 80. By way of example, this coupling carries a multiplicity of articulated radial arms 98 on the collar at pins 100. These arms carry friction pads 102 subjected to the action of return springs 104 and they allow to achieve a clutch coupling between this drum and this collar under the centrifugal effect provided by the rotation of the collar and/or the drum.

Pressure means 28 and 72 of couplings 22 and 70 described above are controlled under the action of control means 106, 108 respectively, such as swivelling levers subjected to the action of a jack (not shown).

A calculator 110 allows control means 106, 108 to be controlled by means of control lines 112 so as to actuate the operating mode of the drive system. This calculator also allows to control the operation of engine 10 and/or of electric machine 14 through lines 114 and it comprises mappings or data charts allowing, mainly according to the driver's requirements, to start either electric machine 14 or engine 10, or both.

The operation of the system is now described in connection with the various configurations illustrated in FIGS. 2 to 14 and with reference to the table hereafter.

| Fig | Description | 70 | 22 | 86 | 84 | 40 | 36 | 14 | 10 | 42 |
|---|---|---|---|---|---|---|---|---|---|---|
| 2 | Thermal engine start-up: | 0 | 1 | 1 | 0 | 0 | 1 | 1 | 1 | 0 |
| | stationary vehicle/battery on | | | | | | | | | |
| | charge stationary vehicle | | | | | | | | | |
| 3 | Thermal engine start-up: | 1 | 1 | 1 | 0 | 1 | 1 | 1 | 1 | 1 |
| | vehicle in forward gear under | | | | | | | | | |
| | electric traction | | | | | | | | | |
| 4 | Electric traction forward gear and | 1 | 0 | 0/1 | 0 | 1 | 0/1 | 1 | 0/1 | 1 |
| | reverse gear | | | | | | | | | |
| | (thermal engine running or not) | | | | | | | | | |
| 5 | Thermal traction without battery | 0 | 0 | 1 | 1 | 3 | 1 | 0 | 1 | 1 |
| | on charge | | | | | | | | | |
| 6 | Thermal traction with battery on | 0 | 1 | 1 | 1 | 3 | 1 | 1 | 1 | 1 |
| | charge for | | | | | | | | | |
| | Nelec. mach. = Ntherm. eng. | | | | | | | | | |
| | (low ratio) | | | | | | | | | |
| 7 | Thermal traction with battery on | 1 | 1 | 0 | 1 | 1 | 3 | 1 | 1 | 1 |
| | charge for | | | | | | | | | |
| | Nelec. mach. = Ntherm. eng. | | | | | | | | | |
| | (high ratio) | | | | | | | | | |
| 8 | Thermal traction with battery on | 1 | 0 | 1 | 1 | 2 | 1 | 1 | 1 | 1 |
| | charge for | | | | | | | | | |
| | Nelec. mach. <> Ntherm. eng. | | | | | | | | | |
| 9 | Thermal traction + electric traction | 0 | 1 | 1 | 1 | 3 | 1 | 1 | 1 | 1 |
| | for | | | | | | | | | |
| | Nelec. mach. = Ntherm. eng. | | | | | | | | | |
| 10 | Thermal traction + electric traction | 1 | 1 | 0 | 1 | 1 | 3 | 1 | 1 | 1 |
| | Nelec. mach. = Ntherm. eng. | | | | | | | | | |
| 11 | Thermal traction + electric traction | 1 | 0 | 1 | 1 | 1 | 1 | 1 | 1 | 1 |
| | for | | | | | | | | | |
| | Nelec. mach. <> Ntherm. eng. | | | | | | | | | |
| 12 | Electric braking energy recovery | 1 | 0 | 0 | 0/1 | 2 | 0/3 | 1 | 0/1 | 1 |
| 13 | Electric braking energy recovery + | 1 | 1 | 0 | 0/1 | 2 | 3 | 1 | 1 | 1 |
| | thermal engine brake | | | | | | | | | |
| 14 | Battery charge by electric braking | 1 | 1 | 0 | 0/1 | 2 | 3 | 1 | 1 | 1 |
| | energy recovery + energy | | | | | | | | | |
| | provided by thermal engine | | | | | | | | | |

In this table, reference numbers 22, 70, 84 and 86 relate to the various couplings already described, reference numbers 36 and 40 to the transmission paths, reference numbers 10 and 14 to the thermal engine and to the electric machine respectively, and reference number 42 to the driven shaft. Values 0 or 1 represent the coupled or uncoupled state of couplings 22, 70 and 84, the free wheel or driving wheel state for one-directional coupling 86, the non-motive or motive transmission state of the transmission paths (with an additional value 2 for a receiving transmission state in the case of engine braking and a value 3 for a state of transmission in motion without power transmission), and the inactive or active state of engine 10, electric machine 14 and driven shaft 42.

One-directional coupling 86 is in the driving wheel state (value 1) when the rotating speed of sleeve 58 (Nf) is higher than the rotating speed of fixed pulley 80 (Np). Similarly, centrifugal coupling 84 is in an active position when one-directional coupling 86 is in the driving wheel state and when the rotating speed of the sleeve (NO is higher than a threshold value (Ne).

FIG. 2 illustrates the start-up of the thermal engine when the vehicle is stationary and calculator 110 manages control means 20 so as not to allow charging of batteries 18. In this configuration, calculator 110 controls through lines 112 means 106 and 108 controlling couplings 22 and 70 in such a way that only pressure means 28 of coupling 22 are actuated. Disc 26 is thus connected in rotation to housing 24 (symbolized by two intersecting inclined lines in FIG. 2) and pressure means 72 of coupling 70 remain inactive, thus leaving pulley 68 free. Shaft 12 of engine 10 is therefore directly connected to rotor 16 of electric machine 14. The calculator then controls the supply of this electric machine by means 20 and batteries 18 for rotation control. This allows this electric machine to be operated as an electric starter by driving into rotation shaft 12 by means of rotor 16 and by starting the thermal engine.

During this start-up stage, the rotating motion of shaft 12 is transmitted to the second pair of conical discs 54, 56 via the first pair of discs 44, 46 and belt 66. This rotating motion is then transmitted to sleeve 58 and to free wheel 86 that will be in a driving wheel configuration by providing the link between this sleeve and collar 94. Since the rotating speed at the level of this collar is below the threshold value Ne, the centrifugal coupling with drum 96 is not achieved and fixed pulley 80 connected to this drum is not driven into rotation. Neither driven shaft 42 nor belt 82 is therefore driven into rotation.

After engine start-up, control means 20 of electric machine 14 are controlled by the calculator to stop supply thereof so that rotor 16 is driven by shaft 12 if pressure means 28 remain actuated. Under the effect of this rotation, machine 14 can run as an electric energy generator and the electric power delivered thereby is used to supply batteries 18.

FIG. 3 illustrates the configuration wherein the thermal engine is to be started when the vehicle circulates, preferably in forward gear, under the action of electric machine 14 that operates as an electric motor.

Calculator 110 therefore controls means 106, 108 in such a way that couplings 70 and 22 are operational, and means 20 for supplying the electric machine through batteries 18 so as to drive it into rotation. Coupling 22 thus allows to connect rotor 16 of electric machine 14 to shaft 12 of the thermal engine. Under the action of the rotation of rotor 16, shaft 12 is driven into rotation until engine 10 is started. As soon as this engine starts, couplings 22 and 70 remain operational and supply of machine 14 is stopped.

During the start-up phase and thereafter, continuity of the vehicle motion is provided by the fact that second transmission path 40 remains constantly active. In fact, coupling 70 allows to connect in rotation loose pulley 68 with rotor 16 that is either driving for engine start-up or driven after this start-up phase. The rotating motion of this pulley is transmitted by belt 82 to fixed pulley 80 that is fixedly connected to driven shaft 42 by driving it into rotation.

As described above in connection with FIG. 2, during the start-up phase and after this phase, the rotating motion of shaft 12 is transmitted to the second pair of conical discs 54, 56 via the first pair of discs 44, 46 and belt 66. This rotating motion is then transmitted to sleeve 58 and to free wheel 86 that will be in a driving wheel configuration by providing a link between this sleeve and collar 94. The centrifugal coupling with drum 96 is not achieved because the rotating speed of the collar, which corresponds to that of pulley 80 (Np), is below threshold value Ne, which however hinders in no way the rotation of the driven shaft through pulley 80.

Another situation consists, after start-up of the thermal engine, in releasing coupling 22 while maintaining traction of the vehicle by the electric motor. The thermal engine can then rev up until centrifugal coupling 84 is operational. The motion is then transmitted to the vehicle by first transmission path 36.

Similarly, after start-up of engine 10, the calculator controls means 20 of electric machine 14 in such a way that it runs as an electric energy generator driven by shaft 12 for supplying batteries 18 or the vehicle accessories if need be.

Thus, in the configuration of FIG. 2 as well as in that of FIG. 3, electric machine 14 is used to provide start-up of the thermal engine, then it can serve as an electric energy generator for supplying the various devices and accessories of the vehicle and/or for recharging the batteries of the vehicle.

For operation of the vehicle in electric traction (in forward or in reverse gear) as illustrated in FIG. 4, machine 14 runs like an electric motor while being supplied by batteries 18 under the control of means 20. For this operation mode, only coupling 70 is operational under the control of calculator 110 by allowing pulley 68 to be connected to rotor 16. The rotating motion of pulley 68 is transmitted by belt 82 to fixed pulley 80 that drives into rotation driven shaft 42, which in return directly or indirectly drives the wheels of the vehicle.

Since coupling 22 is not operational, engine 10 may or may not be running, without the vehicle drive being disturbed thereby and without free wheel 86 being motive.

FIG. 5 illustrates the operating mode of the system with the vehicle being driven by thermal engine 10.

In this case, none of the two couplings 22 or 70 is operational and operation of thermal engine 10 causes rotation of shaft 12.

Under the effect of this rotation, the first pair of conical discs 44, 46 is driven into rotation, a rotation that is transmitted to the second pair of discs 54, 56 and to sleeve 58 by belt 66. Since the speed of the sleeve is higher than that of fixed pulley 80 (pulley in off position), free wheel 86 is motive and drives collar 94 into rotation. Under the effect of the rotating speed and of the centrifugal force, pads 102 of centrifugal coupling 84 come into contact with the inside of drum 96 while driving it, and consequently driven shaft 42, into rotation.

The rotation of fixed pulley 80 has no effect on rotor 16 since coupling 70 is not active and pulley 68 can freely rotate on this rotor under the action of belt 82.

FIGS. 6 to 8 illustrate the system in a configuration for which the vehicle is driven by thermal engine 10 with charging of batteries 18 by means of electric machine 14 that works as an electric energy generator when the engine drives this machine at the same speed with a low (FIG. 6) or a high transmission ratio (FIG. 7), or at different speeds (FIG. 8).

In the case of FIG. 6, calculator 110 controls engine 10 through line 114 and control means 106 and 108 through lines 112 in such a way that the internal-combustion engine is operational and coupling 22 is active while coupling 70 is in an inactive position. In this configuration, the engine drives shaft 12 into rotation, which in turn drives rotor 16 at the same rotating speed through the agency of coupling 22. The rotation of the rotor thus allows to provide charging of batteries 18 by means of electric machine 14 that works as an electric energy generator, under the control of control means 20.

Simultaneously, the rotating motion of shaft 12 is transmitted by first transmission path 36 (first pair of discs 44, 46, belt 66, second pair of discs 54, 56) to sleeve 58. Since the speed of sleeve 58 (Nf) is sufficient to make free wheel 86 motive, the latter drives collar 94 into rotation. Under the effect of this rotation, coupling 84 is operational by thus securing in rotation drum 96 and fixed pulley 80 to sleeve 58. In this position, since the drum is fixedly connected to driven shaft 42, the latter is driven into rotation and consequently provides, directly or indirectly, displacement of the vehicle.

The rotation of fixed pulley 80 has no effect on rotor 16 since coupling 70 is not active and pulley 68 can freely rotate on this rotor under the action of belt 82.

FIG. 7 illustrates another configuration for which the vehicle is driven by thermal engine 10 with charging of batteries 18 by means of electric machine 14, and the engine driving this machine at the same speed by means of a high transmission ratio.

In this case, calculator 110 controls engine 10 through line 114 and control means 106 and 108 through lines 12 in such a way that the internal-combustion engine is operational and couplings 22 and 70 are active by securing, on the one hand, shaft 12 to rotor 16 and, on the other hand, rotor 16 to pulley 68.

Thus, the engine drives into rotation shaft 12 that in turn drives rotor 16 at the same rotating speed by means of coupling 22. The rotation of the rotor thus allows to provide charging of batteries 18 by means of electric machine 14 that works as an electric energy generator.

Furthermore, the rotation of this rotor is transmitted to driven shaft 42 by the second transmission path (pulley 68, belt 82, fixed pulley 80) and it thus allows this driven shaft to be driven into rotation.

The rotation of shaft 12 is transmitted, via belt 66, from the first pair of conical discs 44, 46 to the second pair of discs 54, 56 connected to sleeve 58. Since the speed of fixed pulley 80 (Np) is higher than that of the sleeve (Nf), free wheel 86 is not operational. No motion transmission therefore occurs between transmission path 36 and driven shaft 42.

In the case of FIG. 8, the vehicle is driven by thermal engine 10 with charging of batteries 18 by means of electric machine 14, with a rotating speed of the engine that is different (higher or lower) than that of machine 14.

Calculator 110 therefore controls engine 10 through line 114 and control means 106 and 108 through lines 112 in such a way that the internal-combustion engine is operational and coupling 70 is active by securing pulley 68 to rotor 16 while coupling 22 is inactive by separating this rotor from shaft 12.

The rotating motion of shaft 12 is transmitted by the first pair of conical discs 44, 46 and belt 66 to the second pair of discs 54, 56 and sleeve 58. The speed of sleeve 58 is such that free wheel 86 becomes motive and drives into rotation collar 94. Under the effect of this rotation, centrifugal coupling 84 is operational and allows to secure in rotation drum 96 and fixed pulley 80 to the collar and, consequently, to sleeve 58. Since the drum is fixedly connected to driven shaft 42, the latter is driven into rotation and thus provides direct or indirect displacement of the vehicle.

Furthermore, fixed pulley 80 drives into rotation, by means of belt 82, pulley 68 that has been secured in rotation to rotor 16. Under the action of the rotation of this pulley 68, rotor 16 is driven into rotation and thus allows to provide charging of batteries 18 by means of electric machine 14 that works as an electric energy generator.

FIGS. 9 to 11 illustrate the vehicle drive system in a configuration wherein the vehicle is driven jointly by thermal engine 10 and electric machine 14 when the engine and the machine have the same rotating speed with a low (FIG. 9) or a high transmission ratio (FIG. 10), or when they have different rotating speeds (FIG. 11).

The configurations illustrated by FIGS. 9 to 11 differ from those of FIGS. 6 to 8 only in that machine 14 works as an electric motor to provide, jointly with the thermal engine, displacement of the vehicle.

Thus, in the configuration of FIG. 9 where the positions of the various couplings correspond to those of FIG. 6, coupling 22 is active, coupling 70 is inactive, free wheel 86 is motive, centrifugal coupling 84 is also active, engine 10 is operational and machine 14 works as an electric motor supplied by batteries 18, whose operation is controlled by calculator 110 via control means 20.

The power of electric motor 14 is therefore transmitted from rotor 16 to shaft 12 of the thermal engine via coupling 22. This power adds to the power transmitted to this shaft by the thermal engine and the resulting power is transferred through first transmission path 36 (conical discs 44 and 46, belt 66, conical discs 54 and 56) to driven shaft 42 via sleeve 58, free wheel 86, collar 94, centrifugal coupling 84, drum 96 and fixed pulley 80 connected to this driven shaft.

As already described in connection with FIG. 6, the rotation of fixed pulley 80 has no effect on rotor 16 since pulley 68 can freely rotate on this rotor under the action of belt 82, coupling 70 being inactive.

For the configuration of FIG. 10 (with the positions of the couplings corresponding to those of FIG. 7), couplings 22 and 70 are operational, free wheel 86 is not motive, centrifugal coupling 84 is inactive, the thermal engine is operating and, as in FIG. 9, machine 14 works as an electric driving motor supplied by batteries 18 under the control of calculator 110 via control means 20.

The power generated by thermal engine 10 is transmitted to shaft 12 and it is in turn transmitted to rotor 16 through coupling 22. This power is combined with that of electric motor 14 through its rotor 16. Since coupling 70 is active, the combination of these powers is then transferred to driven shaft 42 by second transmission path 40 (pulley 68, belt 82 and fixed pulley 80).

Since free wheel 86 is not motive, on the one hand, the rotating motion of fixed pulley 80 cannot be transmitted to sleeve 58 and, on the other hand, the rotating motion of shaft 12 transferred by first transmission path 36 to sleeve 58 cannot be transmitted to this fixed pulley.

According to the configuration of FIG. 11 (corresponding to that of FIG. 8), coupling 22 is inactive, coupling 70 is operational, free wheel 86 is motive, centrifugal coupling 84 is active, thermal engine 10 is operating and machine 14 works as an electric driving motor supplied by batteries 18.

In this configuration, the power generated by electric motor 14 is transmitted from rotor 16 to driven shaft 42 by second transmission path 40 (pulley 68, belt 82 and fixed pulley 80), by means of coupling 70. Simultaneously, the power of the thermal engine is transferred from shaft 12 to driven shaft 42 by first transmission path 36 (conical discs 44 and 46, belt 66, conical discs 54 and 56) through free wheel 86, collar 94, centrifugal coupling 84, drum 96 and fixed pulley 80), coupling 22 being inactive.

The configuration of FIG. 12 illustrates the situation of the system in electric energy recovery phase, when the vehicle is subjected to deceleration, upon braking for example.

Therefore, from a configuration where the vehicle is driven either by thermal engine 10 or by electric machine 14, or by both 10 and 14, calculator 110 controls, during deceleration phases of the vehicle, coupling 70 in active position and coupling 22 in inactive position. This calculator also controls the thermal engine, if it is running, so as to idle or to stop it. The rotating speed of shaft 12 transmitted to sleeve 58 by first path 36 is therefore not sufficient to make free wheel 86 motive.

In order to recover this deceleration energy and to convert it to electric energy, the calculator controls machine 14 so that it works as an electric energy generator for charging batteries 18.

Thus, during the deceleration phases, the driving wheels of the vehicle generate a rotating motion that is directly or indirectly transmitted to driven shaft 42. This rotating motion is then transmitted to rotor 16 by second transmission path 40 via fixed pulley 80, belt 82 and pulley 68, coupling 70 being active. The rotation of rotor 16 allows, under control of the calculator and of control means 20, to operate machine 14 as a mechanical energy receiving machine, which mechanical energy will be converted, as with an electric generator, to electric energy in order to be used or stored in batteries 18.

In the configuration of FIG. 13, in addition to the energy recovery of FIG. 12, engine braking is achieved as a complement to vehicle braking.

Coupling 22 is therefore active in addition to the activation of coupling 70 as initially shown in FIG. 12.

Thus, during vehicle deceleration periods, the rotating motion of driven shaft 42 is transmitted to rotor 16 via second transmission path 40. Coupling 22 being active, this rotating motion is also transmitted to shaft 12 that generates a resistant torque on the thermal engine and therefore engine braking.

It can be noted that, in cases where batteries 18 are fully charged, calculator 110 controls machine 14 so as to make it electrically inactive. This allows engine braking to be improved even further.

As for FIG. 14, the configuration is identical to that of FIG. 12, except for the fact that thermal engine 10 supplies energy to ensure charging of batteries 18.

In this case, the energy generated by the deceleration of the vehicle is transmitted to rotor 16, as described in connection with FIG. 12. Calculator 110 furthermore controls engine 10 so that it drives shaft 12 into rotation. The rotating motion of this shaft, and consequently its energy, is transmitted by coupling 22 to rotor 16 that is therefore provided with extra energy to achieve charging of batteries 18 via machine 14 that works as an electric energy generator.

FIG. 15 illustrates a variant of FIG. 1 wherein the first pair of conical discs carried by shaft 12 comprises a modification in relation to that of FIG. 1 insofar as the location of the one-directional coupling (the free wheel) has been changed in relation to that illustrated in FIG. 1. Thus, conical disc 120, which was initially fixed in FIG. 1 (conical disc 44), is fixedly carried by one end of a tube 122 surrounding shaft 12. This tube with conical disc 120 is free in rotation but fixed in translation along shaft 12. The other end of this tube also fixedly carries a flange 124 having the same function as the flange of control means 48 described above in connection with FIG. 1. The opposite mobile conical disc 126 is mounted between conical disc 120 and flange 124 while being free in translation but fixed in rotation on tube 122. The axial displacement of this mobile disc in the direction of conical disc 120 is controlled by control means 48, such as weights 50 that rest on flange 124 and on the outside of conical 126.

As illustrated in FIG. 15, tube 122 is connected to shaft 12 by a one-directional coupling such as a free wheel 128. This free wheel comprises an inner ring 130 connected to shaft 12, rollers 132 resting on the inner ring and on an outer ring 134 connected to tube 122 by flange 124.

The operation of this variant is globally identical to that described in connection with FIGS. 2 to 14. It can however be noted that, during the vehicle deceleration phases, first transmission path 36 is driven by driven shaft 42, which was not the case in the configurations described above in connection with energy recovery.

In the variant of FIG. 16, the centrifugal coupling of FIG. 1 between drum 96 and free wheel 86 has been replaced by a disengageable coupling 136.

Collar 94 therefore carries a coupling disc 138 fixed in rotation with this collar and preferably free in axial translation on this collar. The drum fixedly carries a reaction plate 140 and pressure means 142 also carried by the drum and allowing to provide coupling between disc 138 and this plate 140. The pressure means comprise for example a support plate 144 subjected to the action of spring means 146.

As already mentioned in connection with the disengageable couplings of FIG. 1, disengageable coupling 136 and more particularly its pressure means 142 are controlled by control means (not shown).

The operation of this variant is also identical to that of FIG. 1, but with the advantage of allowing to control the engaging and disengaging range of coupling 136.

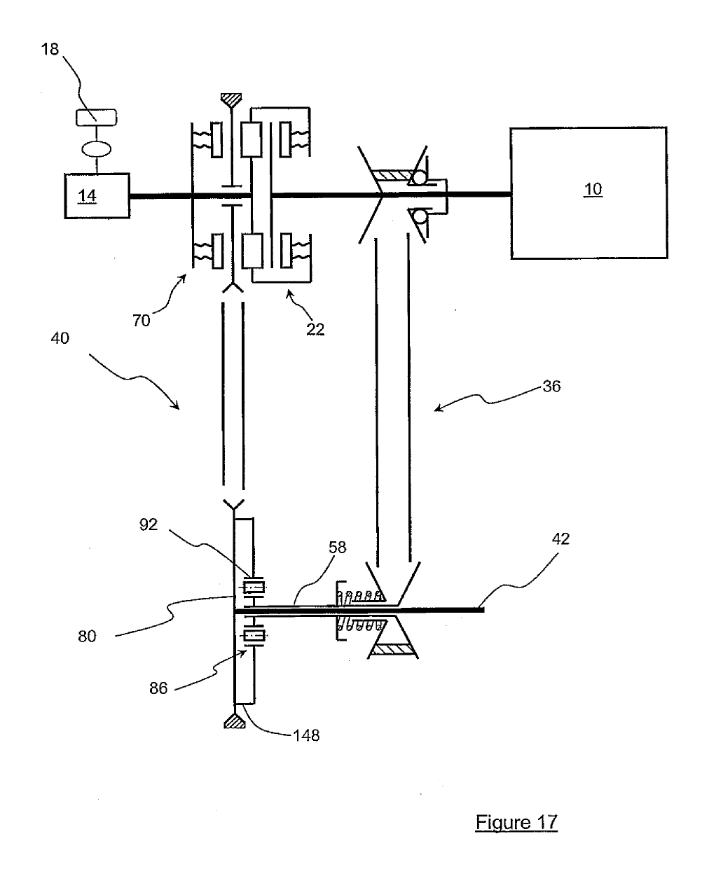

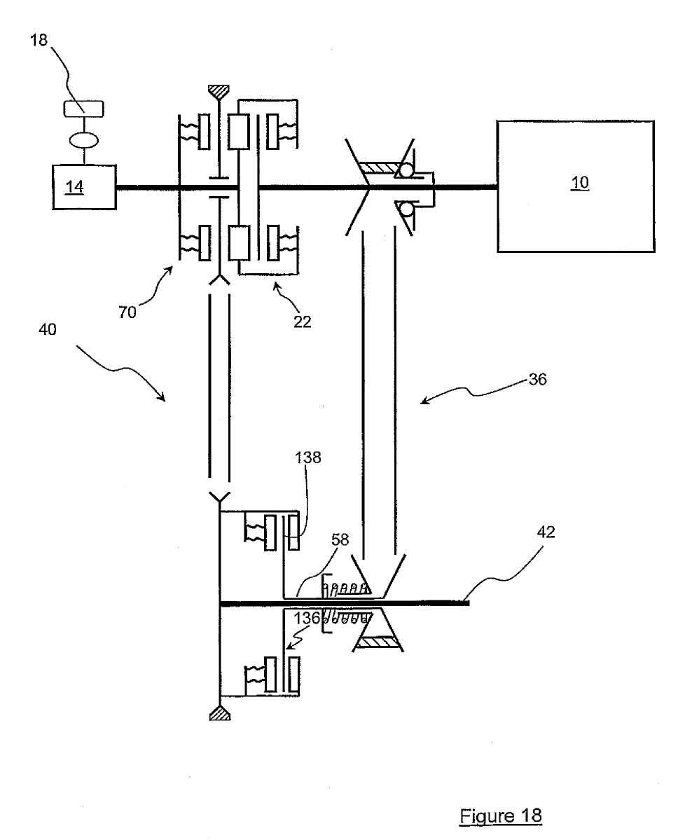

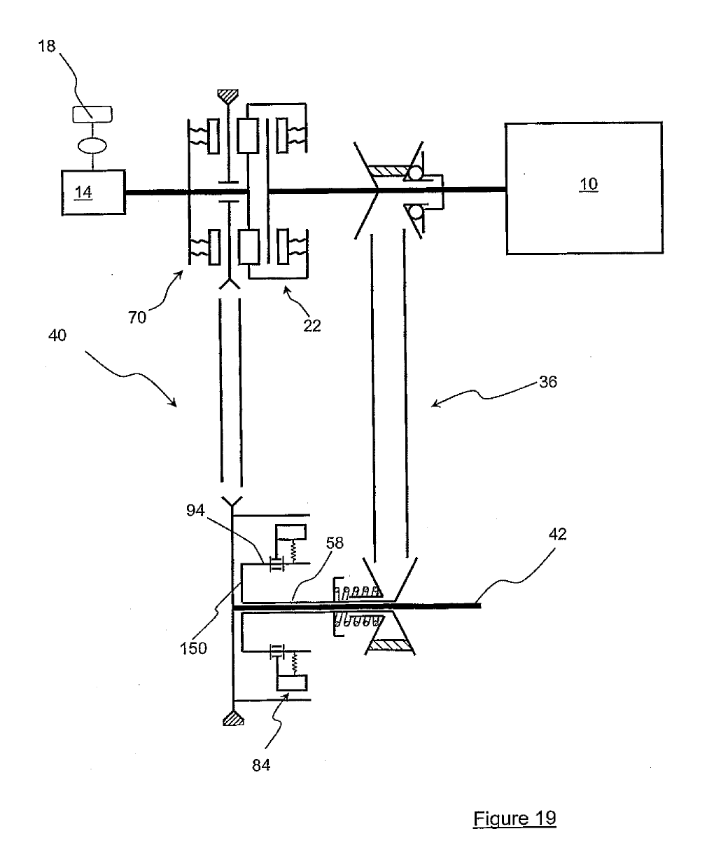

As for the variant of FIG. 17, the (centrifugal or disengageable) coupling initially provided between fixed pulley 80 and free wheel 86 has been suppressed.

The free wheel is therefore directly connected to the fixed pulley by a flat ring 148 fixedly connecting its outer ring 92 to pulley 80.

This layout is particularly advantageous when thermal engine 10 is intended to be systematically stopped when the vehicle is stationary. In order to move the vehicle from its stationary position, machine 14 is used as the electric driving motor. This machine 14 can also be used as a starter for thermal engine 10 by making coupling 22 operational. Once the thermal engine started, its power is transmitted to fixed pulley 80 via first transmission path 36 or sleeve 58 and free wheel 86 (couplings 22 and 70 being inactive).

In the variant of FIG. 18, which is more precisely a variant of FIG. 16, the collar and the free wheel initially provided between coupling disc 138 of disengageable coupling 136 and sleeve 58 have been suppressed.

Disc 138 is therefore fixedly mounted in rotation and preferably free in translation on sleeve 58.

This layout affords the advantage of providing an additional energy recovery path during vehicle deceleration phases. Furthermore, transmission path 36 can allow to achieve engine braking on the thermal engine in a wider engine speed range.

In FIG. 19, the free wheel provided between centrifugal coupling 84 and sleeve 58 has been suppressed.

Collar 94 carrying coupling 84 is thus fixedly connected directly to sleeve 58 through a flank 150.

This layout allows to use first transmission path 36 as an engine brake for thermal engine 10 and/or electric motor 14.

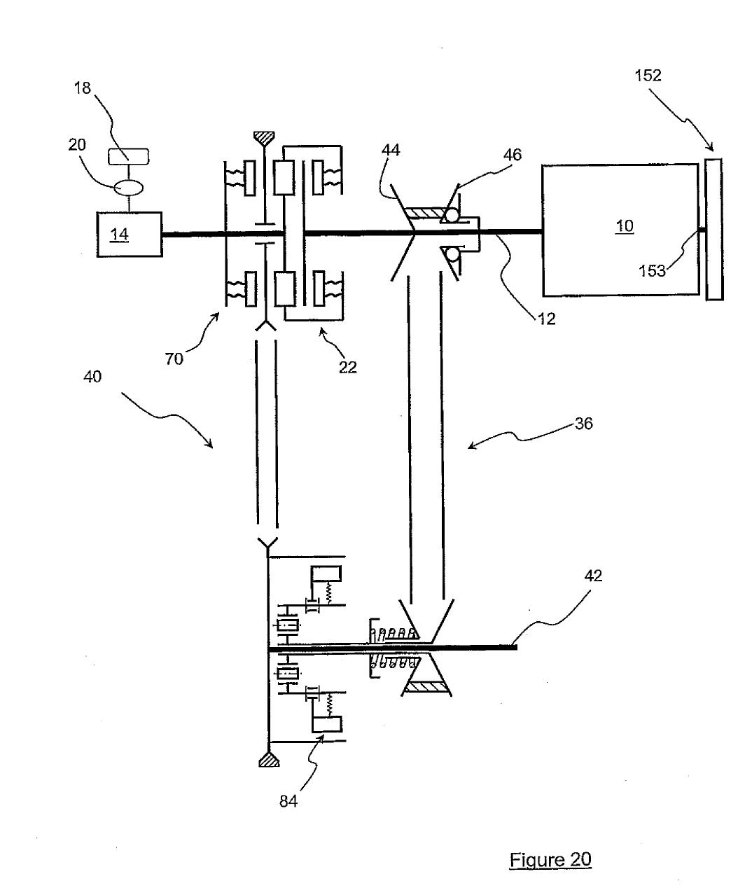

For the variant of FIG. 20, an electric machine 152 mainly used as an electric energy generator is arranged on the shaft of thermal engine 10. It is precisely arranged either on a portion of shaft 12 between the pair of conical discs 44, 46 of transmission path 36 and the engine, or on a shaft extension 153 opposite shaft 12, as illustrated in this figure.

This generator can be connected to control means 20 or comprise specific control means (not shown) controlled by the calculator so as to provide charging of the batteries, drive of the vehicle alone or in combination with the thermal engine, or start-up of this thermal engine.

This allows to obtain series hybrid operation if the speed of thermal engine 10 does not allow coupling 84 to be made operational.

This layout furthermore allows not to be limited as regards the continuous operating time of the vehicle in reverse gear since thermal engine 10 can allow to charge batteries 18 while, simultaneously, these batteries supply energy to electric machine 14 for reversing.

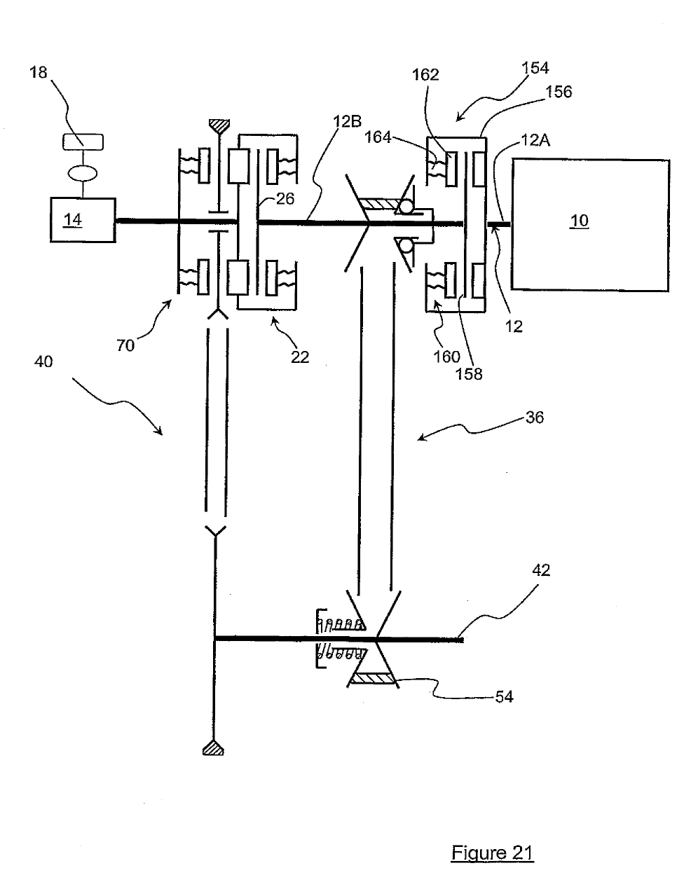

In the example of the variant illustrated in FIG. 21, an additional disengageable coupling 154 is arranged on shaft 12 between transmission path 36 and engine 10, thus dividing this shaft into two parts, a first part 12A between the engine and this coupling, and a second part 12B between this coupling and coupling 22. Furthermore, the free wheel at the level of driven shaft 42, the centrifugal coupling, the collar and the drum have been suppressed while conical disc 54 has been secured in rotation and in translation to driven shaft 42.

The additional coupling comprises a housing 156 carried, fixedly in rotation and in translation, by the free end of first part 12A of the shaft and a coupling disc 158 arranged in the housing while being carried, fixedly in rotation and freely in axial translation, by one end of second part 12B of the shaft, the other end of this shaft carrying coupling disc 26 of coupling 22, as already described in connection with FIG. 1. This additional coupling also comprises pressure means 160 (pressure plate 162 and elastic means 164), arranged in housing 156, allowing to provide coupling between disc 158 and housing 156 so as to enable simultaneous rotation of parts 12A and 12B of shaft 12.

This affords the advantage of neutralizing transmission path 36 by disengaging coupling 154 or of setting, between part 12B of shaft 12 and driven shaft 42, any other speed variation means, such as a discontinuous variation means, a gear box for example. Thus, changing these gears (manually or automatically) will be conventionally done by disengaging coupling 154.

As for the other variants, the operating mode of the variants of FIGS. 17 to 20 is globally similar to that of the system of FIG. 1.

The present invention is not limited to the example described above and it encompasses any variant or equivalent.

Similarly, the thermal engine mentioned in the above description covers internal-combustion engines running on fossil fuels such as gasoline, diesel fuel or gas, as well as biofuels of ethanol type or others.

1) A travel drive system for a hybrid vehicle, comprising a thermal engine, notably an internal-combustion engine, with a shaft, at least one electric machine with a rotor supplied by batteries, a disengageable coupling between said shaft and said rotor, and a driven shaft driving the wheels of the vehicle, characterized in that it comprises a first transmission path for motion transmission between shaft of thermal engine and driven shaft, and a second transmission path for motion transmission between rotor of machine and said driven shaft.

2) A drive system as claimed in claim 1, characterized in that at least one of the paths comprises a variable gear transmission.

3) A drive system as claimed in claim 2, characterized in that the transmission comprises a continuously variable gear transmission.

4) A drive system as claimed in claim 3, characterized in that the continuously variable gear transmission comprises two pairs of variable spacing pulleys connected by a belt.

5) A drive system as claimed in claim 2, characterized in that the variable gear transmission comprises a gear box.

6) A drive system as claimed in claim 1, characterized in that at least one of the paths comprises a fixed gear transmission.

7) A drive system as claimed in claim 6, characterized in that fixed gear transmission comprises two pulleys connected by a belt.

8) A drive system as claimed in claim 1, characterized in that it comprises a disengageable coupling between rotor of electric machine and the second transmission path.

9) A drive system as claimed claim 1, characterized in that it comprises a coupling between first transmission path and shaft of engine.

10) A drive system as claimed in claim 1, characterized in that it comprises at least one coupling between driven shaft and first transmission path.

11) A drive system as claimed in claim 9, characterized in that the coupling comprises a centrifugal coupling.

12) A drive system as claimed in claim 9, characterized in that the coupling comprises a one-directional coupling.

13) A drive system as claimed in claim 9, characterized in that the coupling comprises a disengageable coupling.

14) A drive system as claimed in claim 1, characterized in that it comprises an additional electric machine driven by engine.

15) A method for travel drive of a hybrid vehicle comprising a thermal engine, notably an internal-combustion engine, with a shaft, at least one electric machine with a rotor supplied by batteries, a disengageable coupling between said shaft and said rotor, and a driven shaft driving the wheels of the vehicle, characterized in that it consists in connecting driven shaft by a first motion transmission path to shaft of thermal engine and/or by a second motion transmission path to rotor of electric machine.

16) A method for travel drive of a hybrid vehicle as claimed in claim 15, characterized in that it consists, for starting thermal engine, in supplying electric machine by batteries so as to operate it as an electric starter and in connecting rotor of this machine to shaft of engine through coupling.

17) A method for travel drive of a hybrid vehicle as claimed in claim 15, characterized in that it consists, jointly with the operation of thermal engine and drive of driven shaft by first transmission path, in charging batteries through actuation of the electric machine via coupling between shaft of the engine and rotor of the machine.

18) A method for travel drive of a hybrid vehicle as claimed in claim 15, characterized in that it consists, jointly with the operation of thermal engine and drive of driven shaft by first transmission path, in driving said driven shaft through electric machine by connecting its rotor to shaft of engine.

19) A method for travel drive of a hybrid vehicle as claimed in claim 15, characterized in that it consists, jointly with the operation of thermal engine and drive of driven shaft by first transmission path, in driving said driven shaft through electric machine by means of second transmission path.

20) A method for travel drive of a hybrid vehicle as claimed in claim 15, characterized in that it consists, jointly with the operation of thermal engine and drive of driven shaft by second transmission path, in driving said driven shaft through thermal engine by connecting its shaft to rotor through coupling.

21) A method for travel drive of a hybrid vehicle as claimed in claim 15, characterized in that it consists, during deceleration phases of the vehicle, in recovering the mechanical energy of driven shaft in order to transmit it to rotor of electric machine by connecting said rotor to second transmission path through coupling.

22) A method for travel drive of a hybrid vehicle as claimed in claim 15, characterized in that it consists, during deceleration phases of the vehicle, in recovering the mechanical energy of driven shaft in order to transmit it to rotor of electric machine by connecting said rotor to second transmission path through coupling and to transmit it to shaft of engine by making coupling between the rotor and the shaft operational.
